(19) United States
(12) Patent Application Publication
(10) Pub. No.: US 2022/0037750 A1
(43) Pub. Date: Feb. 3, 2022

(54) SECONDARY BATTERY

(71) Applicant: Panasonic Corporation, Kadoma-shi, Osaka (JP)

(72) Inventor: Yukio Harima, Hyogo (JP)

(73) Assignee: Panasonic Corporation, Kadoma-shi, Osaka (JP)

(21) Appl. No.: 17/277,388

(22) PCT Filed: Jul. 22, 2019
(86) PCT No.: PCT/JP2019/028607

§ 371 Date: Mar. 18, 2021

(30) Foreign Application Priority Data
Sep. 26, 2018 (JP) 2018-180107

(51) Int. Cl. H01M 50/566; H01M 50/531; H01M 50/534; H01M 50/55

(52) U.S. Cl. CPC H01M 50/566; H01M 50/55; H01M 50/534; H01M 50/531

(57) ABSTRACT

A secondary battery includes: an electrode body which has a positive and a negative plate inserted in a battery case; a sealing plate which seals an opening in the case; and an external terminal attached thereto. One end of the positive and the negative plate is provided with a current collection tab, the one end closer to the sealing plate, the current collection tab is connected to the external terminal via a current collection terminal member disposed between the electrode body and the sealing plate, in a joined area between the current collection tab and the current collection. terminal member a joined portion of the current collection tab has a recessed form due to joining by ultrasonic wave, and a depth of the recessed form of a joined portion of an end closer to the electrode body is smaller than a depth of the recessed form of other joined portions.

### TECHNICAL FIELD

The present invention relates to a secondary battery.

### BACKGROUND ART

In recent years, lithium-ion secondary batteries are preferably used as power supplies for vehicle or power supplies for PC and mobile terminals. As one of these types of lithium-ion secondary batteries, a battery structure is known, including an electrode body in which positive and negative electrodes with a separator interposed therebetween are alternately stacked. For instance, PTL 1 discloses a lithium-ion secondary battery, in which multiple positive electrodes and negative electrodes, and separators alternately stacked are housed in a rectangular case. In the PTL 1, in the positive electrodes and the negative electrodes, multiple projection members (tabs) comprised of respective base material layers (metal foils) are stacked to form tab sections, which are joined to a positive electrode current collector and a negative electrode current collector by ultrasonic joining. The positive electrode current collector and the negative electrode current collector are electrically connected to a positive electrode terminal and a negative electrode terminal, respectively provided outwardly of the lid of the rectangular case.

In PTL 2, an ear member (tab) and a lead tab of a laminated lithium-ion secondary battery are ultrasonic welded. This battery has a problem in that the lead tab is broken due to vibration when in transport or in use, and it is disclosed that the cause is a recessed form into which a quadrangular pyramid trapezoidal shape is embedded in welded portions made by ultrasonic welding. It is disclosed that in order to solve the problem, welding marks are designed to have a chamfered contour so that sharp four-corner shape of the recessed form is eliminated.

### CITATION LIST

### Patent Literature

PTL 1: Japanese Published Unexamined Patent Application No. 2018-139191

PTL 2: Japanese Published Unexamined Patent Application No. 2013-165054

### SUMMARY OF INVENTION

In the lithium-ion secondary battery formed as in PTL 1, in an assembly process, the assembling is performed in the following order: an electrode body is housed in a rectangular case, and subsequently, an opening of the rectangular case is closed by a lid. At this point, the assembling is performed in the following order: the tab members are joined to the positive electrode current collector and the negative electrode current collector, then the rectangular case is covered by a lid. When covered by a lid, stress is applied to the tab member, the positive electrode current collector and the negative electrode current collector. In other words, when the tab members are joined to the positive electrode current collector and the negative electrode current collector by ultrasonic wave, joining is performed in a state where no stress is applied to both, however, when assembly is performed, the opening is covered in a state where the tab member comprised of a metal foil is bent, in other words, in a state where stress is applied to the tab members.

Particularly, in recent years, the battery capacity per unit volume is strongly demanded to be increased, thus measures need to be taken to increase the ratio of the volume of the positive electrode and the negative electrode occupied in the battery case as much as possible. Therefore, the space which can be occupied by the members other than the positive electrode and the negative electrode in the battery case is increasingly reduced. Due to such circumstances, the tab members, the positive electrode current collector and the negative electrode current collector are housed in an extremely small space in the assembly process described above. As a result, housing is performed with large stress applied to joined portions between the tab members, and the positive electrode current collector and the negative electrode current collector.

The tab members are comprised of a metal foil, thus are bent upon application of stress. However, the positive electrode current collector and the negative electrode current collector are comprised of a metal plate, thus are not bent by the stress at the time of assembly. In this case, application of stress causes the tab members to be bent, but does not cause the positive electrode current collector and the negative electrode current collector to be bent, thus the stress due to the bending is focused on the joined portions between the tab members, and the positive electrode current collector and the negative electrode current collector, thus there is a possibility that, the tab members are broken at ends of the joined portions. Here, it has been found that even if the technique disclosed in PTL 2 is applied, the bending cannot be coped with, and yet there is a possibility of breakage.

The present invention has been devised in light of such a view, and it is an object to provide a secondary battery having a structure that can prevent breakage of the current collection tabs in the assembly process.

A secondary battery of the present invention includes: a battery case having an opening; an electrode body which has a positive plate and a negative plate and is inserted in the battery case; a sealing plate which seals the opening; and an external terminal attached to the sealing plate. One end of each of the positive plate and the negative plate is provided with a current collection tab, the one end being closer to the sealing plate, the current collection tab is electrically connected to the external terminal via a current collection terminal member disposed between the electrode body and the sealing plate, the current collection tab and the current collection terminal member are joined by ultrasonic wave, in a joined area between the current collection tab and the current collection terminal member, a joined portion of the current collection tab has a recessed form due to joining by the ultrasonic wave, and a depth of the recessed form of a joined portion of an end closer to the electrode body is smaller than a depth of the recessed form of other joined portions.

It is preferable that the depth of the recessed form of the joined portion of the end closer to the electrode body be 50% or greater and 80% or less of the depth of the recessed form of the other joined portions.

A plurality of current collection tabs may be provided, each of which is the current collection tab that may be comprised of a metal foil.

According to the present invention, when a secondary battery is assembled, breakage of the current collection tabs can be reliably prevented.

### BRIEF DESCRIPTION OF DRAWINGS

FIG. 1 is a cross-sectional view schematically illustrating a secondary battery according to an embodiment.

FIG. 2 is a schematic view illustrating the configuration of an electrode body.

FIG. 3 is a view schematically illustrating a state where a positive plate, a negative plate and a separator are stacked.

FIG. 4 is a schematic perspective view of positive electrode current collection tabs which are stacked and placed on a positive electrode-side current collection terminal member.

FIG. 5 is a schematic perspective view of the positive electrode current collection tabs and the positive electrode-side current collection terminal member joined by ultrasonic wave.

FIG. 6 is an enlarged schematic plan view illustrating of the portion where the positive electrode collection tabs and the positive electrode-side current collection terminal member are joined by ultrasonic wave.

FIG. 7 is a schematic perspective view illustrating a state where the positive electrode collection tabs and the positive electrode-side current collection terminal member are joined by ultrasonic wave.

FIG. 8 is a schematic perspective view illustrating a state where the positive electrode-side current collection terminal member is placed on a sealing plate.

FIG. 9 is a schematic perspective view illustrating a state where the positive electrode-side current collection terminal member and a positive electrode-side terminal connection member are welded.

FIG. 10 is a schematic cross-sectional view illustrating a state where the electrode body is inserted in a battery case along with the sealing plate.

FIG. 11 is a schematic cross-sectional view illustrating a state where the battery case, in which the electrode body is inserted, is sealed by the sealing plate.

FIG. 12 is a schematic cross-sectional view illustrating a state where the battery case, in which an electrode body according to a reference embodiment is inserted, is sealed by the sealing plate.

FIG. 13 is an enlarged schematic view of an ultrasonic joining portion according to the reference embodiment.

FIG. 14 is an enlarged schematic view of an ultrasonic joining portion according to the embodiment.

FIG. 15 is a partial enlarged schematic view of an ultrasonic joining device used in the reference embodiment.

FIG. 16 is a partial enlarged schematic view of an ultrasonic joining device used in the embodiment.

### DESCRIPTION OF EMBODIMENTS

Hereinafter, an embodiment of the present invention will be described in detail based on the drawings. The description of the following preferred embodiment is only illustrative substantially, and is not intended to limit the present invention, the object to be applied, and application of the invention. In the following drawings, for the sake of simplicity, components having substantially the same function are indicated by the same reference symbol. Also, the following drawings are schematically illustrated, thus hatching to be applied to a cross-section is omitted, part of members is omitted, and a dimensional scale ratio is changed part by part.

### Embodiment 1

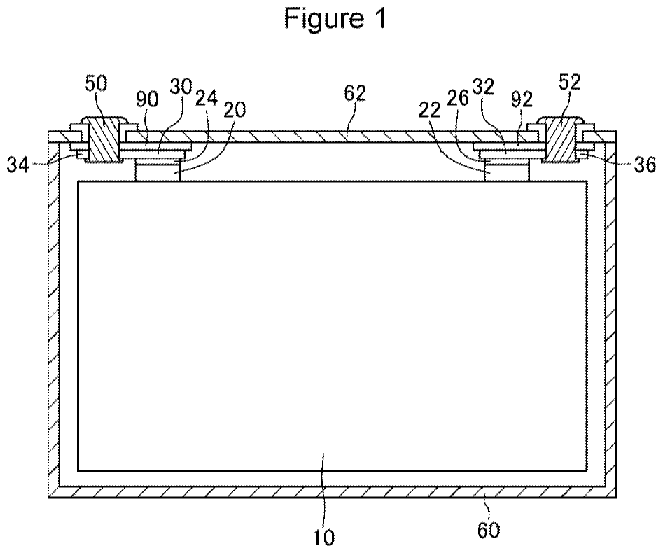

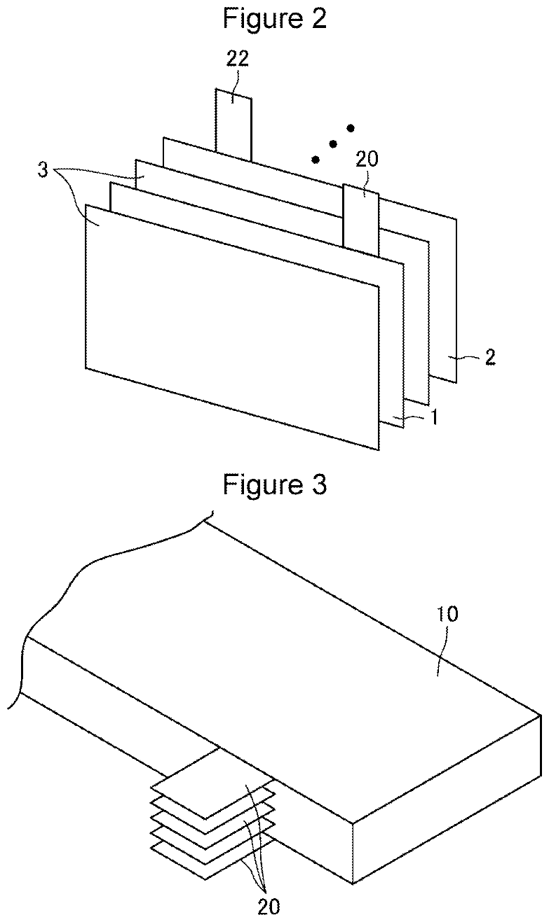

In a lithium-ion secondary battery according to the present embodiment, as illustrated in FIG. 1, an electrode body 10 is housed in a battery case 60 having an opening, and the opening of the battery case 60 is sealed by a sealing plate 62. As illustrated in FIG. 2, in the electrode foody 10, multiple sets of a positive plate 1 and a negative plate 2 with a separator 3 interposed therebetween are stacked, one end (upper-side end) of the positive plate 1 is provided with a positive electrode current collection tab 20, and one end of the negative plate 2 is provided with a negative electrode current collection tab 22. The positive electrode current collection tab 20 and the negative electrode current collection tab 22 are comprised of a metal foil.

In the electrode body 10, multiple positive electrode current collection tabs 2 are bundled and joined to a positive electrode-side current collection terminal member and multiple negative electrode current collection tabs 22 are bundled and to a negative electrode-side current collection terminal member 24 indicates the portion where the bundled positive electrode current collection tabs 20 are placed on the positive electrode-side current collection terminal member 30, and 26 indicates the portion where the bundled negative electrode current collection tabs are placed on the negative electrode-side current collection terminal member 32. The positive electrode-side current collection terminal member 30 and the negative electrode-side current collection terminal member 32 are comprised of a metal plate.

The positive electrode-side current collection terminal member 30 is electrically connected via a positive electrode-side terminal connection member 34 to a positive electrode terminal (an external terminal on the positive electrode side) 50 attached to the outer surface side of the sealing plate 62, and the negative electrode side current collection terminal member 32 is electrically connected via a negative electrode-side terminal connection member 36 to a negative electrode terminal (an external terminal on the negative electrode side) 52 attached to the outer surface side of the sealing plate 62. The positive electrode-side terminal connection member 34 and the negative electrode-side terminal connection member 36 are comprised of a metal plate. It is to be noted that a positive electrode-side insulation member 30 is disposed between the positive electrode-side current collection terminal member 30 and the positive electrode-side terminal connection member 34, and the sealing plate 62, and a negative electrode-side insulation member 92 is disposed between the negative electrode-side current collection terminal member 32 and the negative electrode-side terminal connection member 36, and the sealing plate 62.

Next, the joining between the positive electrode current collection tabs 20 and the positive electrode-side current collection terminal member 30 will be described using FIG. 3 to FIG. 7. It is to be noted that the joining between the negative electrode current collection tabs 22 and the negative electrode-side current collection terminal member 32 is performed in a similar manner.

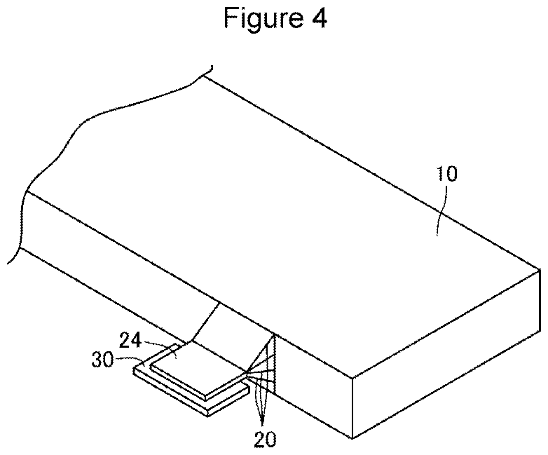

FIG. 3 is a view illustrating a state where the positive plate 1, the negative plate 2, and the separator 3 illustrated in FIG. 2 are stacked to form the electrode body 10 only on the side in which the positive electrode current collection tabs 20 project. These multiple positive electrode current collection tabs 20 are bundled and stacked, and placed on the positive electrode-side current collection terminal member 30 (FIG. 4).

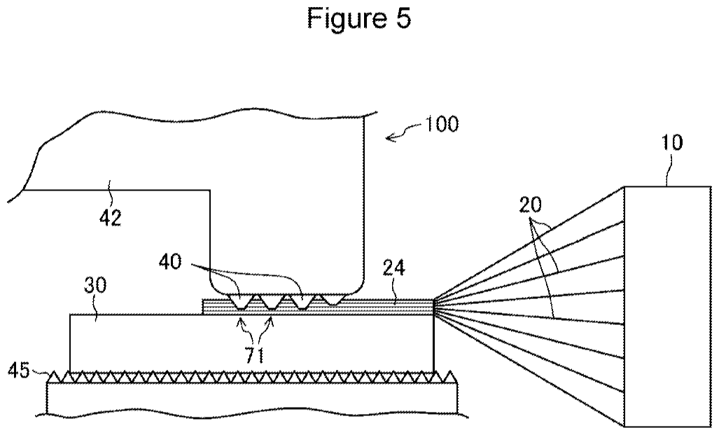

Then, as illustrated in FIG. 5, the positive electrode current collection tabs 20 and the positive electrode-side current collection terminal member 30 are joined using an ultrasonic joining device 100. The ultrasonic joining device 100 performs ultrasonic joining with the members to be joined interposed by a horn 42 provided with multiple knurls (projections) 40 used for joining, and an anvil 45. One surface of the positive electrode-side current collection terminal member 30 is placed on the anvil 45, the one surface being opposite to the other surface on which the positive electrode current collection tabs 20 are placed, the knurls 40 are pressed into the upper surface of the positive electrode current collection tabs 20, and are moved downward while vibrating the horn 42 by ultrasonic wave. Then, the knurls 40 compress and cause the positive electrode current collection tabs 20 to be recessed, and the positive electrode current collection tabs 20 and the positive electrode-side current collection terminal member 30 are heated and joined by frictional heat due to ultrasonic vibration. It is to be noted that since the knurls 40 are projections in a quadrangular pyramid trapezoidal shape, joined portions 71 have a recessed form corresponding to the shape of the knurls 40.

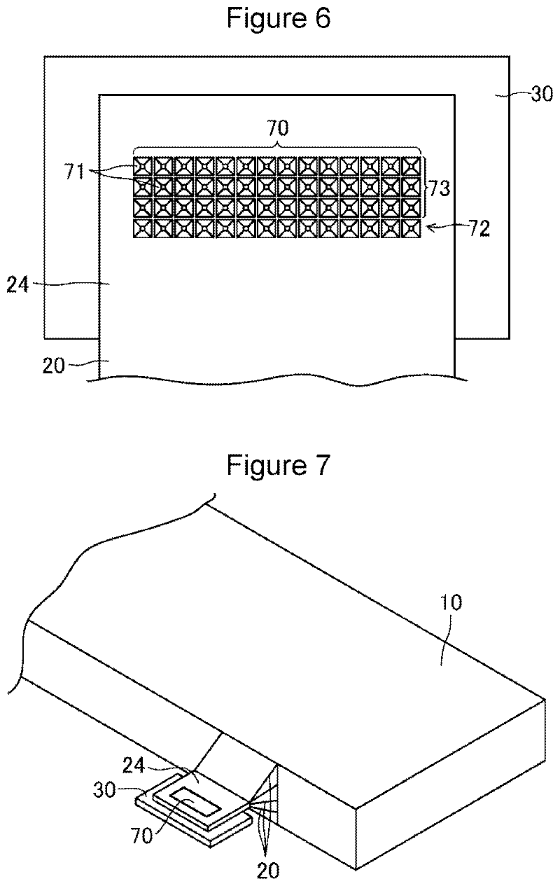

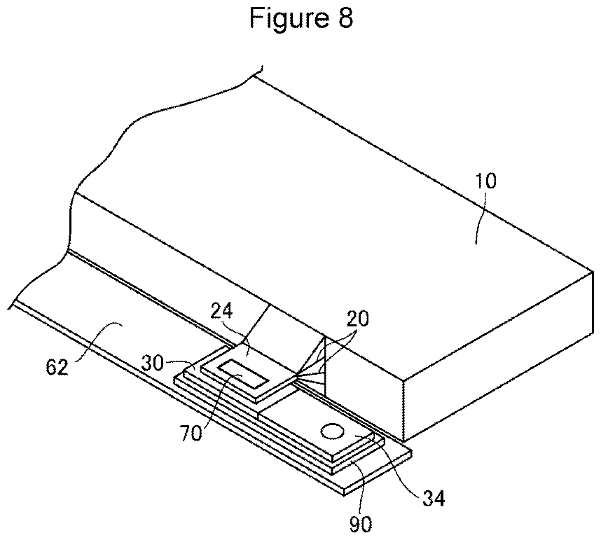

FIG. 6 illustrates a state, as viewed from above, of the joined positive electrode current collection tabs 20 and positive electrode-side current collection terminal member 30. Also, FIG. 7 illustrates a state as viewed diagonally from above. In a joined area 70, multiple joined portions 71 in a recessed form are arranged adjacently to form rows in the direction perpendicular to the longitudinal direction (direction extending from the positive electrode body) of the positive electrode current collection tabs 20, and the multiple rows are arranged adjacently in the longitudinal direction of the positive electrode current collection tabs 20. The multiple joined portions 71 are densely formed in this manner, thus the joining strength is improved. The rows where the joined portions 71 are arranged are grouped into an end-side row 72 consisting of the joined portions 71 arranged on the end closer to the electrode body 10, and rows 73 other than the end. This will be described later.

Hereinafter, the assembly process after the state illustrated in FIG. 7 will be described using FIG. 8 to FIG. 11.

As illustrated in FIG. 8, the sealing plate 62, a positive electrode terminal 50, the positive electrode-side insulation member 90 and the positive electrode-side terminal connection member 34 are connected and fixed in advance, and on the member in which these are integrated, the positive electrode-side current collection terminal member 30, to which the positive electrode current collection tabs 20 are joined, is placed. A surface of the positive electrode-side current collection terminal member 30 is placed on the above-described member, the surface being on the opposite side of the surface joined to the positive electrode current collection tabs 20. In addition, the positive electrode-side current collection terminal member 30 is placed so as to be adjacent to the positive electrode-side terminal connection member 34.

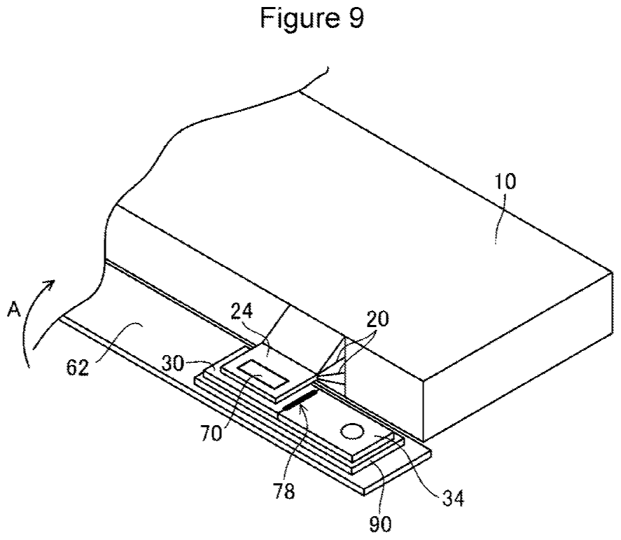

As illustrated in FIG. 9, the adjacent portion between the positive electrode-side current collection terminal member 30 and the positive electrode-side terminal connection member 34 is welded to form a welded portion 78. The welding is performed by laser welding, for instance.

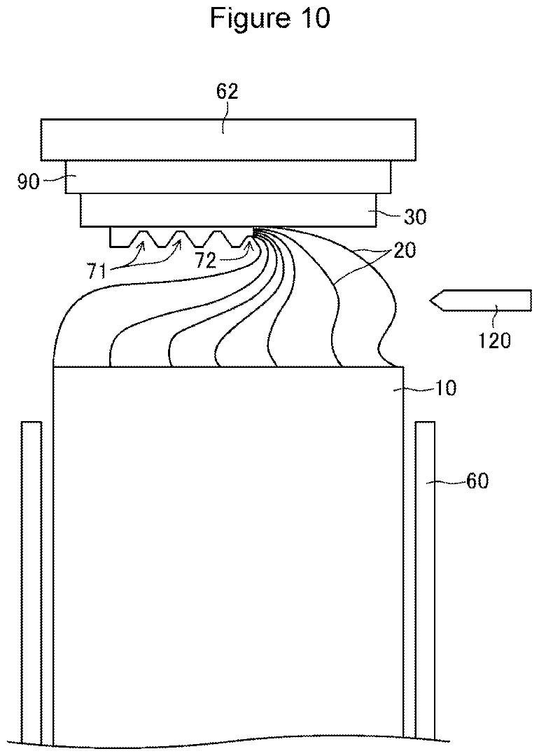

After the welding illustrated in FIG. 9 is performed, the sealing plate 62 is rotated in the direction of an arrow A, and the electrode body 10 is inserted into the battery case 60 as illustrated in FIG. 10. At this point, when the sealing plate 62 is brought closer to the battery case 60, the positive electrode current collection tabs 20 project outwardly of the battery case 60, thus the positive electrode current collection tabs 20 are pushed in using a push member 120 so as to be housed inside the battery case 60. In FIG. 10, the push member 120 is brought into contact with the positive electrode current collection tabs 20, and moved in the left direction, thereby causing the positive electrode current collection tabs 20 to be pushed in.

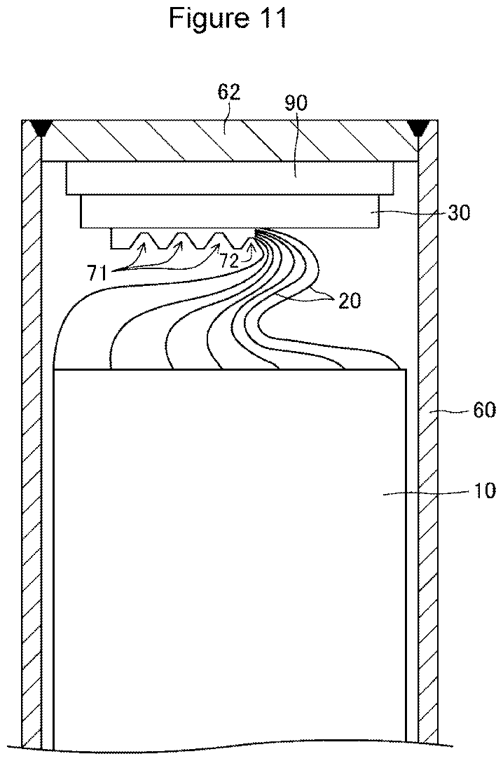

Then, as illustrated in FIG. 11, the battery case 60 is sealed by the sealing plate 62, and the sealing plate 62 and the battery case 60 are welded, fixed and tightly sealed. In this manner, a lithium-ion secondary battery according to the present embodiment is completed.

Next, the joined state between the current collection tabs and the current collection terminal members of the present embodiment will be described in comparison with the reference embodiment.

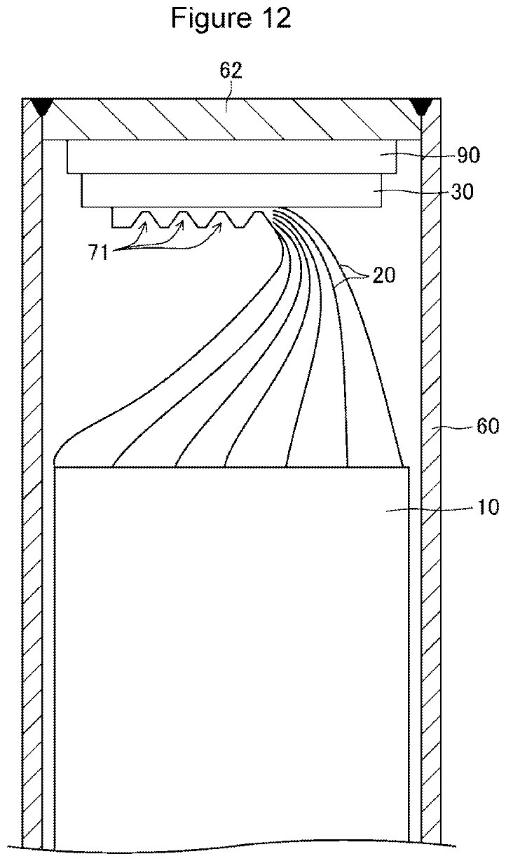

FIG. 12 is a schematic cross-sectional view of a lithium-ion secondary battery according to the reference embodiment. In the reference embodiment, the distance between the electrode body 10 and the sealing plate 62 is greater than the distance according to the present embodiment. Thus, in the reference embodiment, even in a state where the battery case 60 is sealed by the sealing plate 62, the degree of bending of the positive electrode current collection tabs 20 is low. Also, in the process of inserting the electrode body 10 into the battery case 60, the positive electrode current collection tabs 20 do not project outwardly of the battery case 60, thus as illustrated in FIG. 10 of the present embodiment, it is not necessary to push in the positive electrode current collection tabs 20 by the push member 120. Thus, in the reference embodiment, as compared with the present embodiment, bending of the positive electrode current collection tabs 20 due to the pushing in does not occur.

When the positive electrode current collection tabs 20 are bent, stress is applied, which reduces the joining between the positive electrode current collection tabs 20 and the positive electrode-side current collection terminal member 30. The stress is first concentrated on the joined portions provided on the end side closer to the electrode body 10, which are the boundary section between the positive electrode current collection tabs 20 and the joined area 70. In the reference embodiment, although all the multiple joined portions 71 have a recessed form with the same depth, the degree of bending of the positive electrode current collection tabs 20 is low. Thus, even when stress is concentrated on the joined portions 71 provided on the end side closer to the electrode body 10, the stress itself is small, and the welding does not come off, and the positive electrode current collection tabs 20 are not broken.

However, in the present embodiment, as compared with the reference embodiment, the degree of bending of the positive electrode current collection tabs 20 is higher. Particularly, in the process of inserting the electrode body 10 into the battery case 60, the degree of bending is the highest at the time of push by the push member 120, and stress is applied, which reduces the joining between the positive electrode current collection tabs 20 and the positive electrode-side current collection terminal member 30. Under such a situation, it has been found that in the joined portions according to the reference embodiment, the positive electrode current collection tabs 20 may be broken in the joined portions provided on end side closer to the electrode body 10.

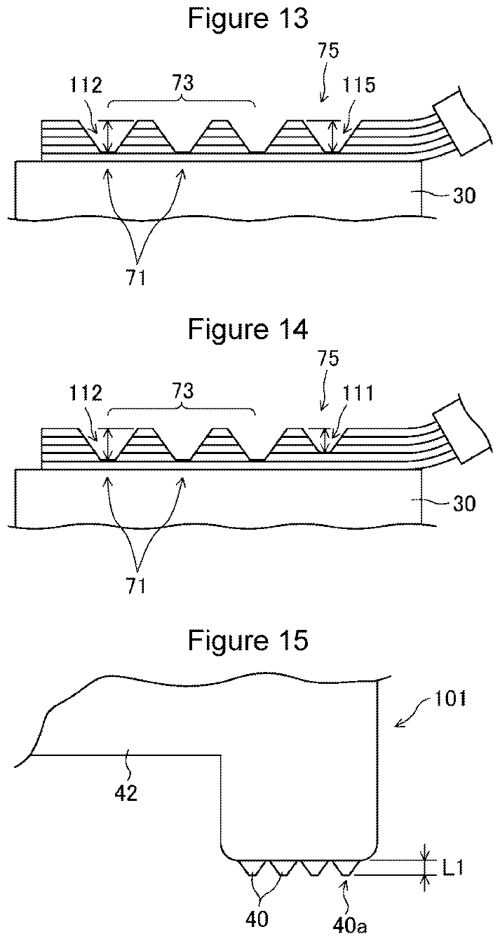

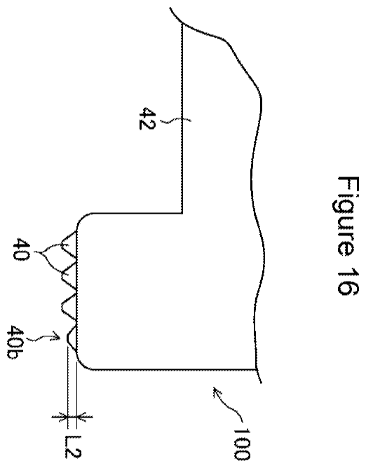

After study of the broken portions, it has been found that the joined portions are made thinner, and breakage occurs because their thickness cannot endure the stress. In the reference embodiment, as illustrated in FIG. 13, a depth 115 in a recessed form of an end-side joined portion 75 in the row at the end closer to the electrode body 10 is the same as a depth 112 in a recessed form of the joined portions 71 other than the end-side joined portion 75. This is because ultrasonic joining is performed using an ultrasonic joining device 101 illustrated in FIG. 15, and a height L1 of end-side knurls 40a forming the end-side joined portion 75 is the same as the height of other end-side knurls 40.

In the ultrasonic joining, the knurls 40 are pressed and vibration by the ultrasonic wave is given thereto, thus the gap between the multiple positive electrode current collection tabs 20 is eliminated, and the portions in contact with the leading faces of the knurls 40 are pushed out to the periphery, thereby causing the thickness of the positive electrode current collection tabs 20 itself to be reduced. The smaller the thickness, the greater the joining strength between the positive electrode current collection tabs 20 and the positive electrode-side current collection terminal member 30, thus the electrical resistance of the joined portion is reduced. However, the positive electrode current collection tabs 20 itself has a reduced thickness, thus the mechanical strength against the stress is decreased.

Even with a reduced thickness of the positive electrode current collection tabs 20, if a portion is firmly joined to the positive electrode-side current collection terminal member 30, the portion is not broken even under application of the stress at the time of bending of the positive electrode current collection tabs 20. However, in the positive electrode current collection tabs 20, the boundary section between a sufficiently joined portion and an unjoined portion has a reduced thickness and the joining itself is in almost no or insufficient state. Thus, the boundary section may be broken upon application of the above-mentioned stress thereto.

In order to avoid such a situation, as illustrated in FIG. 14, in the present embodiment, in the end-side joined portion 75 in the row 72 at the end closer to the electrode body 10 and the joined portions 71 in the rows 73 other than the end, a depth ill in a recessed form of the end-side joined portion 75 is made smaller than a depth 112 in a recessed form of the joined portions 71 in the rows 73 other than the end. In order to form such joining, an ultrasonic joining device 100 illustrated in FIG. 16 is used. A height L2 of end-side knurls 40b forming the end-side joined portion 75 is lower than the height, of other end-side knurls 40.

Here, it is preferable that the depth 111 in a recessed form of the end-side joined portion 75 be 50% or greater and 80% or less of the depth 112 in a recessed form of the joined portions 71 in the rows 73 other than the end. In the case where the depth 111 is less than 50% of the depth 112, the joining strength is insufficient, and when the positive electrode current collection tabs 20 are significantly bent, the joining at the end-side joined portion 75 may come off. Also, in the case where the depth 111 is greater than 80% of the depth 112, when the positive electrode current collection tabs 20 are significantly bent, breakage of the positive electrode current collection tabs 20 may occur. It is to be noted that the joining strength and the low electrical resistance required for the joined area 70 are ensured by the joined portions 71 in the rows 73 other than the end.

According to the present embodiment, even if the positive electrode current collection tabs 20 and the negative electrode current collection tabs 22 are significantly bent due to vibration, impact at the time of assembly of the battery or at the time of use of the battery, the positive electrode current collection tabs 20 and the negative electrode current collection tabs 22 can be prevented from being broken, and the product-defect rate at the time of assembly can be reduced as well as the battery can be provided with a high vibration-resistant, impact-resistant ability.

### Other Embodiments

The above-described embodiment is an illustration of the present invention, and the present invention is not limited to these examples. These examples may be combined with or partially replaced by a well-known technique, a commonly used technique, or a publicly known technique. In addition, modified invention that easily occurs to those skilled in the art is also included in the present invention.

### REFERENCE SIGNS LIST

1 POSITIVE PLATE

2 NEGATIVE PLATE

10 ELECTRODE BODY

20 POSITIVE ELECTRODE CURRENT COLLECTION TAB

22 NEGATIVE ELECTRODE CURRENT COLLECTION TAB

30 POSITIVE ELECTRODE-SIDE CURRENT COLLECTION TERMINAL MEMBER

32 NEGATIVE ELECTRODE-SIDE CURRENT COLLECTION TERMINAL MEMBER

50 POSITIVE ELECTRODE TERMINAL (EXTERNAL TERMINAL)

52 NEGATIVE ELECTRODE TERMINAL (EXTERNAL TERMINAL)

60 BATTERY CASE

62 SEALING PLATE

70 JOINED AREA

71 JOINED PORTION

72 ROW ON END SIDE (ROW CONSISTING OF JOINED PORTIONS AT END CLOSER TO ELECTRODE BODY)

73 ROW AT OTHER THAN END (ROW CONSISTING OF JOINED PORTIONS AT OTHER THAN END CLOSER TO ELECTRODE BODY)

1. A secondary battery comprising:
a battery case having an opening; an electrode body which has a positive plate and a negative plate and is inserted in the battery case: a sealing plate which seals the opening; and an external terminal attached to the sealing plate,
wherein one end of each of the positive plate and the negative plate is provided with a current collection tab, the one end being closer to the sealing plate,
the current collection tab is electrically connected to the external terminal via a current collection terminal member disposed between the electrode body and the sealing plate,
the current collection tab and the current collection terminal member are joined by ultrasonic wave,
in a joined area between the current collection tab and the current collection terminal member, a joined portion of the current collection tab has a recessed form due to joining by the ultrasonic wave, and
a depth of the recessed form of a joined portion of an end closer to the electrode body is smaller than a depth of the recessed form of other joined portions.

2. The secondary battery according to claim 1,
wherein the depth of the recessed form of the joined portion of the end closer to the electrode body is 50% or greater and 80% or less of the depth of the recessed form of the other joined portions.

3. The secondary battery according to claim 1,
wherein a plurality of current collection tabs are provided, each of which is the current collection tab that is comprised of a metal foil.
